(19) United States
(12) Patent Application Publication
(10) Pub. No.: US 2005/0278446 A1
(43) Pub. Date: Dec. 15, 2005

(54) Home improvement telepresence system and method

(76) Inventor: Jeffery Bryant, Rockville, MD (US)

Correspondence Address: LITMAN LAW OFFICES, LTD, PO BOX 15035, CRYSTAL CITY STATION, ARLINGTON, VA, 22215, US

(21) Appl. No.: 10/854,187

(22) Filed: May 27, 2004

(51) Int. Cl. G06F 15/16; H04B 7/15

(52) U.S. Cl. 709/227

(57) ABSTRACT

The home improvement telepresence system and method is an Internet based system in which a plurality of home-based subscribers obtain real time audio and video support from a pool of experts trained in the subscribers area of interest. The subscriber wears a headset having a camera, microphone, earpiece, and light source mounted thereon. The headset is wirelessly connected to a subscriber-supplied computer having a high-speed connection to the Internet by which means browser software installed on the computer communicates with the home improvement computer server. The server software schedules and routes incoming calls from remote subscribers to computer workstations manned by expert in the subscriber's area of concern.

### BACKGROUND OF THE INVENTION

1. Field of the Invention

The present invention relates to remote support service systems, and particularly to a business method for providing telepresence technical support to home subscribers over the Internet.

2. Description of the Related Art

In recent years we have seen an explosion in the do-it-yourself home repair industry where homeowners have flocked to mega hardware stores to attempt such home repair or re-modeling tasks including sink replacement, window improvement, room extensions, and electric lighting improvement to name but a few. While many of these stores are well stocked with product, finding technical expertise to support a customer in the improvement of these products is more likely than not, unavailable or in short supply.

The nature of business organizations is generally such that, in most any subject, there are a relatively small number of persons with extensive training and experience and a relatively large number of persons with limited training. Technology has come to the rescue by providing a means to leverage the knowledge of a trained expert by providing a communication link between the inexperienced personnel at the job site and the expert located at a central location. Technology has coined a new word “telepresence” and has defined this word to mean being there without actually being there by means of a computer-generated environment consisting of interactive simulations and computer graphics in which a human being experiences being present in a remote location.

U.S. Pat. No. 6,317,039, issued to John Thomason, in November 2001, and U.S. Patent Publication No. 2002/0186668, disclose a method and system for remote assistance and review of a technician or multiple technicians, in real time. The system includes a technician worn apparatus consisting of a video and audio sensor, such as a camera and a microphone, and a receiver for the communication link such as an earphone or speaker and a wireless portable data processor. The communication link comprises a wireless communication path to/from the centralized location that further comprises a video and audio display, software that allows for real-time communication to multiple technicians, and a transmitter for the communication link with the remote job site.

U.S. Pat. No. 6,342,915, issued to Ozaki et al., in January 2002, discloses an image telecommunications system comprising a worker's device and a manager's device. The worker's device collects an image of an object and transmits it to the manager's remote location, so that the image is displayed on a display screen at the manager's location. The manger's device suppresses fluctuations of the image displayed on the display screen, when the image transmitted is relatively unchanged.

U.S. Patent Publication No. 2002/0141619, published in October 2002, for Standridge et al., includes a video and audio processing system for transmission of a video frame across a network. The system includes a video input mechanism, a motion detection mechanism, and a web cam mechanism. The motion detection mechanism is configured to compare a first video frame with a second video frame. It is also configured to generate a motion-detected signal if the comparison of the frames deviates from a threshold value. The web cam mechanism is configured to transmit the second video frame if it received the motion detection signal from the motion detection mechanism. The disclosure also includes a method for processing a selected video frame for transmission across a network. The method includes receiving a video frame, comparing it with a reference frame to determine if it deviates from a threshold value, and transmitting the video frame if it does deviate from the threshold value or discarding it if does not.

U.S. Patent Publication No. 2003/0050851, published in March 2003, discloses a hybrid business hybrid business model incorporating elements from both e-commerce and traditional business support services, specifically, a service center comprising an independent business support staff having expertise in the relevant e-commerce business. The individuals within the service center are linked together via a mobius loop telecommunications network; and, such network is infinitely variable to permit addition or deletion of service center personnel, based upon fluctuations in business volume.

U.S. Pat. No. 5,619,183, issued toZiegra et al. in April 1997, discloses a method and system for remote assistance and review of an operator working with complex equipment. An operator at a station at a local site is coupled to an advisor at a station at a remote site, so that the advisor may view and hear the same stimuli as the operator, that the advisor and operator may communicate, and that the advisor may view and control the local apparatus.

U.S. Pat. No. 6,223,165, issued in April 2001 to Randall Lauffer, discloses a method and apparatus for facilitating the delivery of advice to consumers using a server unit, which can store and display the names and characteristics of experts and then rapidly assist in connecting the expert and consumer for real-time communication. The server can also have the ability to receive keywords from the consumer, match those keywords to one or more experts, and tell the consumer how to contact an expert. In another embodiment, the '165 patent provides for a matching system or relevance scoring method which finds the best expert to answer a consumer's question. This can involve any method of assignment of numbers to the number of keyword matches or matches between ranges of characteristics desired by the consumer with the actual expert characteristics.

None of the above inventions and patents, taken either singly or in combination is seen to describe an Internet based home improvement telepresence support service as claimed. Thus a home improvement telepresence system and method solving the aforementioned problems is desired.

### SUMMARY OF THE INVENTION

The home improvement telepresence system and method is a business method whereby home based subscribers to the service are provided audio and video technical support from home improvement experts over the Internet, whereby a technical expert at a remote location not only is in voice communication with the subscriber, but the expert can see what the subscriber sees and is capable of downloading written instructions and technical data to the subscriber's computer over the Internet.

Accordingly, it is a principal object of the invention to provide a business method and system whereby home subscribers, by means of a audio visual headset in wireless communication with their home based personal computer, can obtain expert advice by means of the Internet in home improvement matters from a help desk staffed with experts in the subscriber's area of interest.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a network diagram of a home improvement telepresence system and method according to the present invention.

FIG. 2 is an environmental perspective view of a service subscriber wearing the wireless headset to communicate with the remote expert via the subscriber's home computer and Internet connection.

FIG. 3 is an environmental perspective view of a subscriber wearing the telepresence headset according to the present, invention.

FIG. 4 is a block diagram showing the configuration of the subscriber's home personal computer according to the present invention.

FIG. 5 is an environmental perspective view showing a customer service representative or technical expert supporting a remote subscriber.

FIG. 6 is a top-level flowchart of the system and method according to FIG. 1.

FIG. 7A is an intermediate level flowchart of the connection stage of the top-level flowchart of FIG. 6.

FIG. 7B is a flowchart that follows where FIG. 7A leaves off and addresses the payment process for the system and method according to FIG. 6.

FIG. 8 is an intermediate level flowchart of the customer service stage of client support according to the top level flowchart of FIG. 6.

FIG. 9 is an intermediate level flowchart of the expert support session with the remote subscriber according to the top level flowchart of FIG. 6.

FIG. 10 is an intermediate level flow chart of the reporting process according to the top-level flowchart of FIG. 6.

Similar reference characters denote corresponding features consistent throughout the attached drawings.

### DETAILED DESCRIPTION OF THE PREFERRED EMBODIMENT

The present invention is an Internet service whereby a subscriber to the service pays an annual fee to obtain real time on demand technical support from a pool of knowledgeable personnel having expertise in those areas of home improvement most needed by the home do-it-yourselfer.

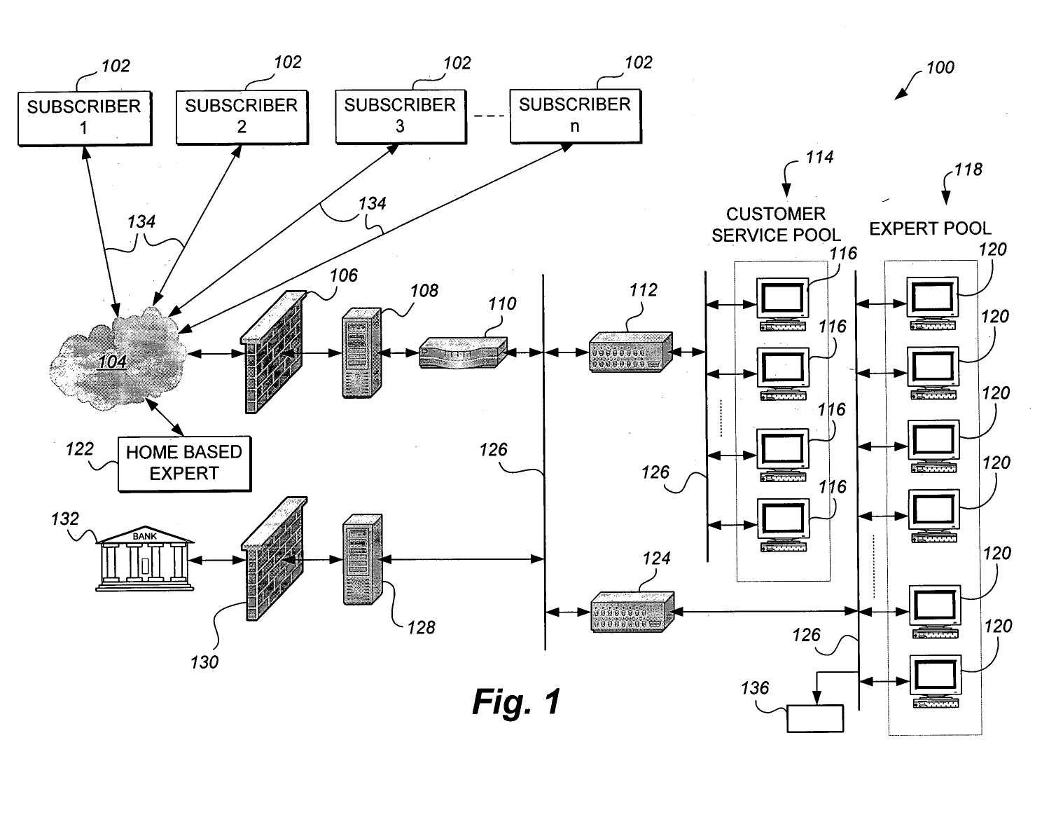

Designated generally as 100 in the drawings, the system 100, as shown in the network diagram of FIG. 1 comprises a number of subscribers 102 connected to the Internet 104 via a wide band connection 134 such as a cable modem or DSL. It is over this subscriber purchased connection 134 that a two-way integrated voice and data communication channel is established between the subscriber 102 and the customer service pool 114 and the pool 118 of technical experts 120. Although non-limiting, the greater the bandwidth capability of the network connection 134, the greater the quality of service provided the subscriber.

Internetworking technology is known to those knowledgeable in the art and includes, but is not limited to, firewalls 106, 130, servers 108, 128, printers 136, routers 110, Ethernet switches 112, 124, structured cable system 126 as well as software protocols and languages such as HTML, XML, Java, NetMeeting and CGI scripting. The technology disclosed herein is subject to change as new devices emerge and are available in the public domain. Furthermore, with advances in teleworker technology, virtual LANs and high speed Internet service readily available in many neighborhoods, the technical expert 122 is no longer physically chained to a physical suite collocated with other customer service representatives. Virtual LAN and other readily available technologies allow a customer service representative 116 or technical expert 120 to be home-based while remaining, for all intents and purposes, part of the customer service or expert pools 114, 118 respectively. The application software residing on the server 108 detects the on-line status of the remote expert 122 at time of logon and routes an on-line support session to the expert based upon the expert's profile. The home-based expert retains all capability of the collocated pool of experts 120 and the workstation hardware is functionally identical to that of the other experts. In subsequent discussions, the home-based expert 122 is implicitly implied whenever the expert workstation is discussed.

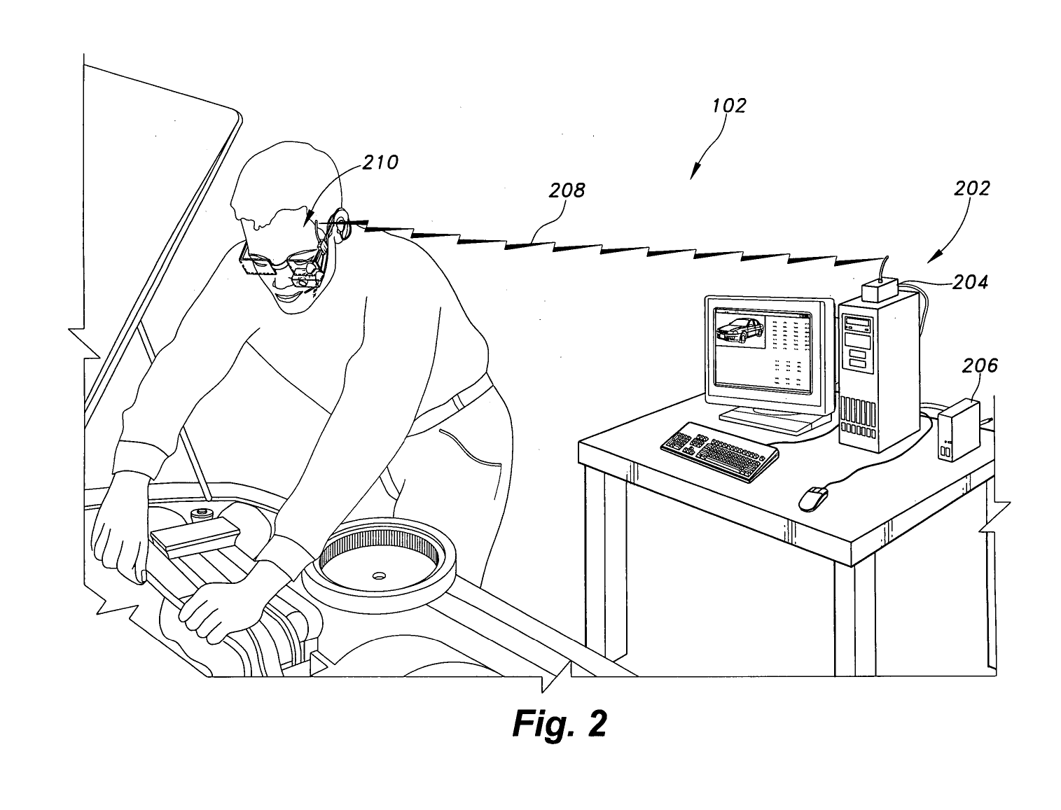

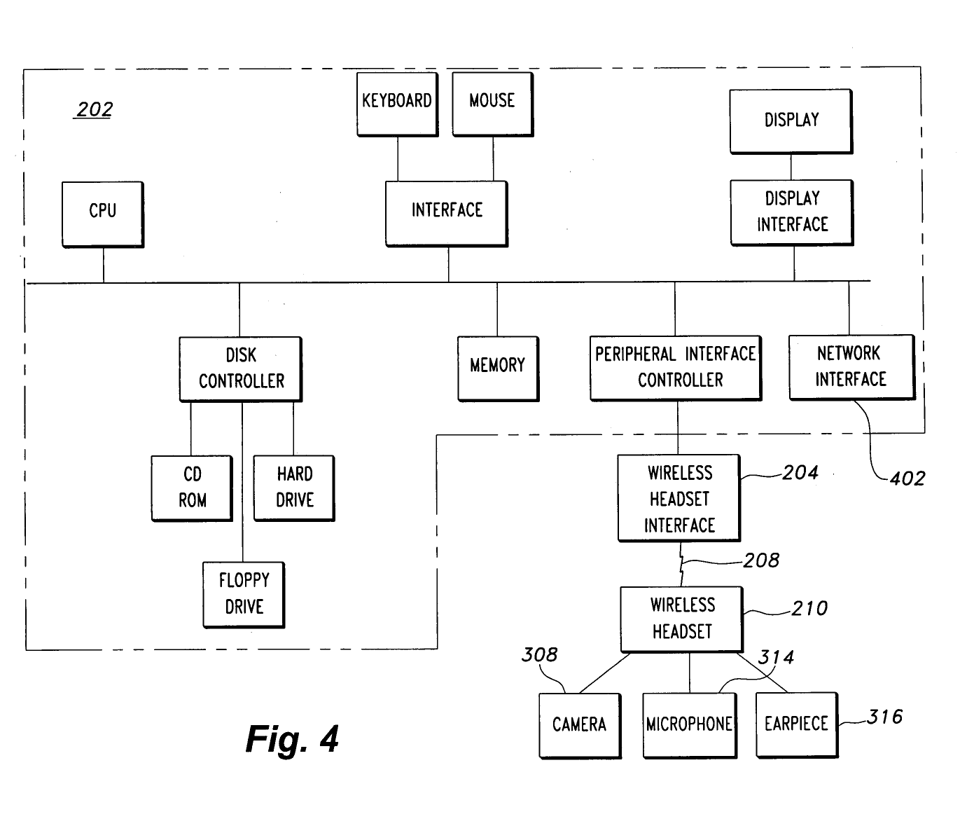

The equipment at a subscriber site 102 is best illustrated by FIGS. 2-4. As seen in FIG. 2, the subscriber is wearing a telepresence headset 210 connected, via a Radio Frequency (RF) link 208, to an RF interface 204 connected to the subscriber's home computer system 202. Although the wireless interface currently utilizes RF technology, any wireless technology known to those skilled in the art may be utilized. The home computer system 202, best shown by the block diagram of FIG. 4, is supplied by the subscriber, and is equipped with standard hardware and software including but not limited to a CPU, a monitor, an operating system, memory and browser application software. Standard in most current computers, a network interface card 402 is required and must be connected to a high speed Internet connection box 206 such as a cable modem or DSL splitter. Although the headset 210 and wireless headset interface 204 are currently provided in the current business method 100, the subscriber is responsible for providing the personal computer 202, the high-speed Internet service 134, and any required Internet connection device 206.

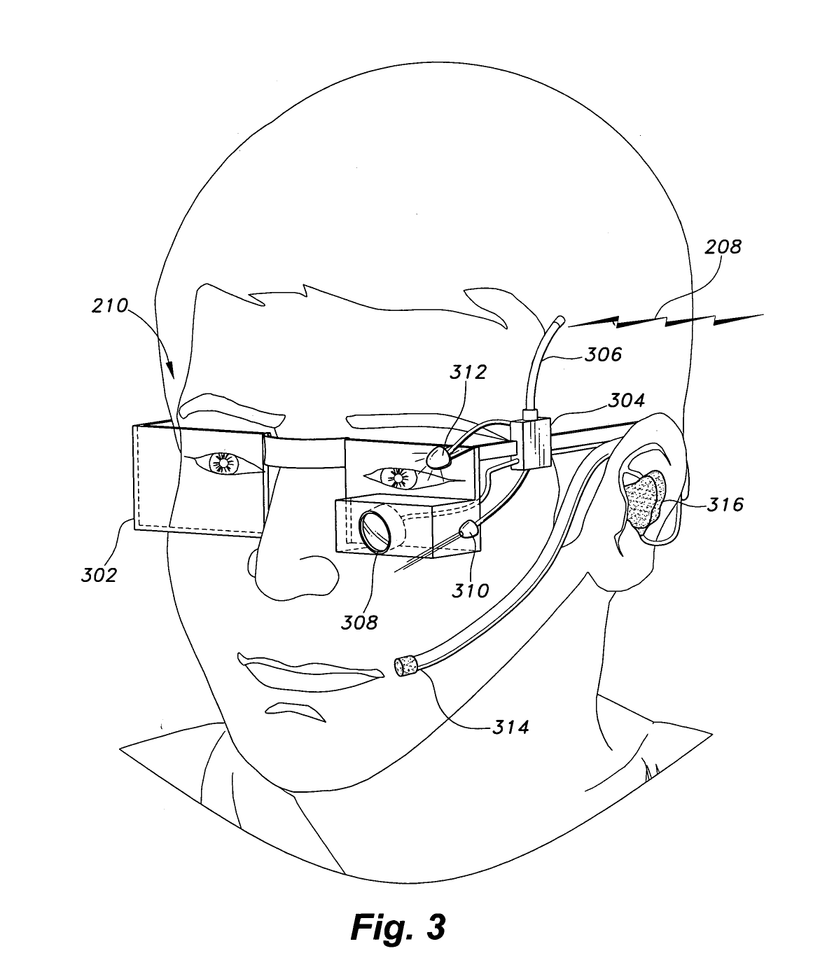

The wireless headset 210, best shown in FIG. 3, is a state-of-the-art telepresence appliance incorporating an eyeglass frame 302 with non-prescription plastic lenses. The frame 302 serves as the mounting base for all electronic components in addition to providing eye protection recommended for anyone working in a potentially hazardous environment. The electronic components mounted on the frame 302 include a miniature camera 308, a high intensity spotlight 312, a microphone 314, an audio earpiece 316, and electronic circuitry 304 for transmitting and receiving the combined video and audio signals by means of antenna 306. Optionally, a laser-pointing device 310 may be incorporated in the headset 210 to facilitate the directing the subscriber to a specific point of gaze requested by the expert.

As shown in FIG. 1, the subscriber equipment 102 is electrically connected by means of the Internet 104 to a suite of network devices. These devices route the subscriber's call to two pools 114, 118 of workstations manned by service professionals. The first pool 114 comprises workstations 116 manned by customer service representatives who are the first line of support personnel. These representatives take the initial call, gather information and resolve any issues prior to being turned over to an expert technician if applicable. The pool of experts 118 man workstations 120 and are trained in multiple disciplines within the home improvement industry, including but not limited to plumbing, electronics, carpentry, masonry, automotive, outdoor, and garden. In the present embodiment of the system 100, the customer service pool receives the initial call, however, an alternative process would have the system 100 route the call directly to an expert under certain circumstances.

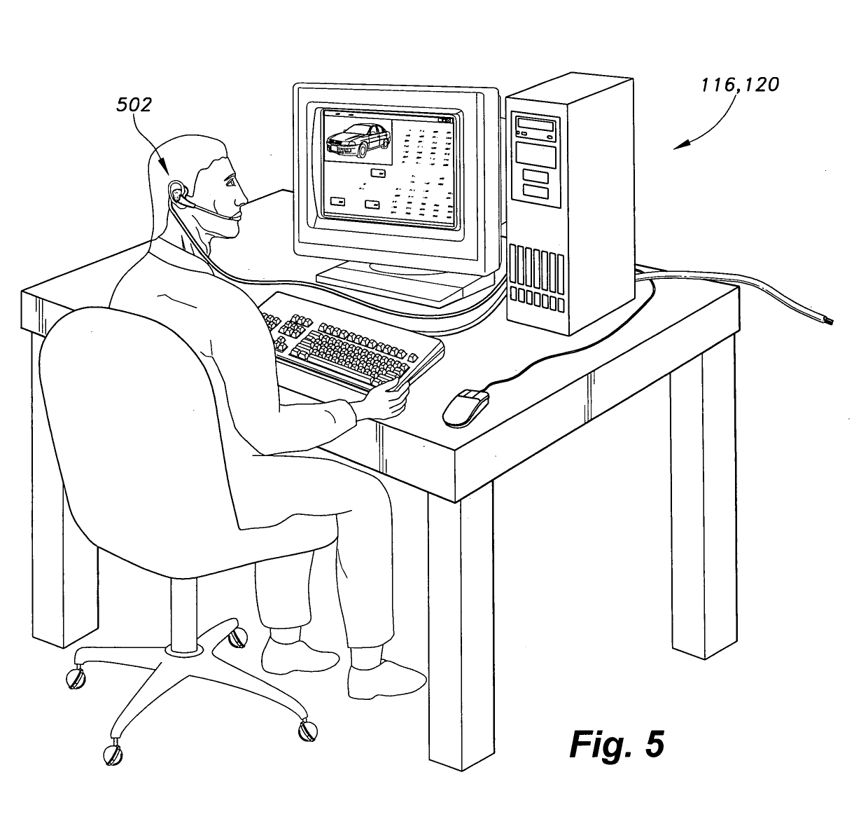

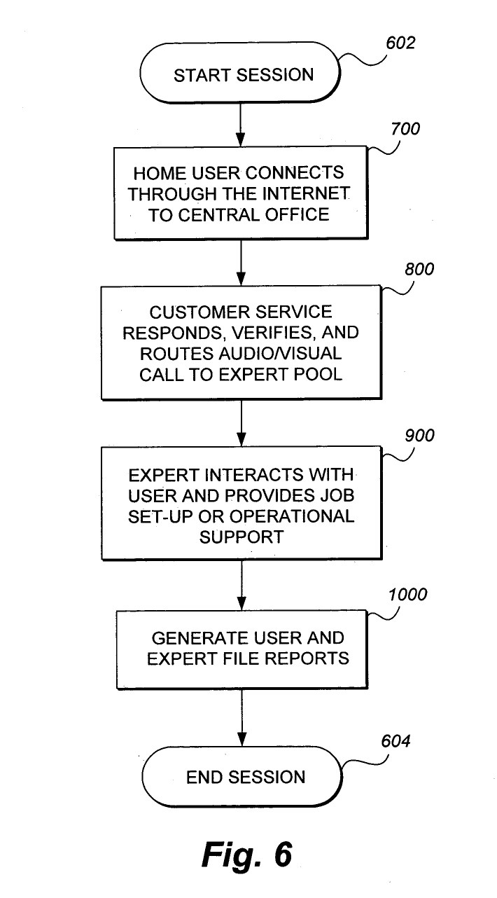

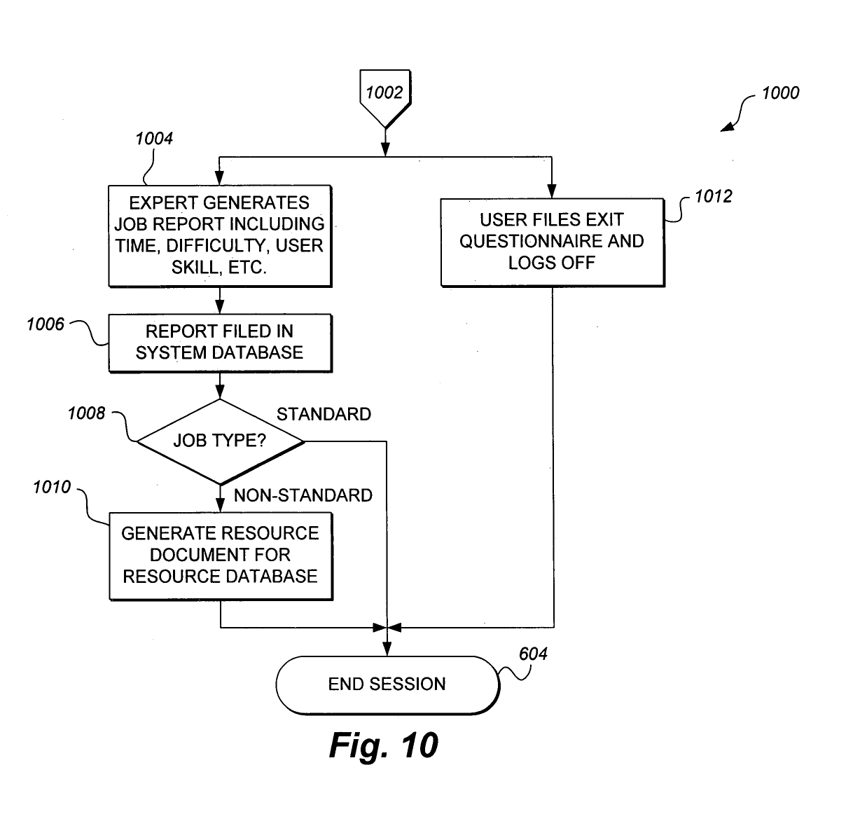

As shown in FIG. 5, each customer service workstation 116 and expert workstation 120 is equipped with a display terminal a central processor unit, and an audio headset 502 connected to the central processor unit. Unlike the headset worn by the subscriber, the headset 502 is a relatively simple device having a microphone and earpiece. The video signal captured by the camera mounted on the headset 210 is displayed on the workstation's display terminal. The specific software functions available to the customer service representative 114 and expert 118 are dependent upon their specific logon profile. The customer service representative 116 and technical expert 118 are presented calls and interactive displays based upon the software flow diagrams described in detail in FIGS. 6-10.

Prior to a subscriber 212 logging into the network, the home improvement telepresence system and method 100 must have customer service representative and technical experts logged into their respectively workstations 116 and 118. As previously disclosed, the service representatives and experts need not be collocated. Pools of experts 118 may be dispersed across the city, state, or country, all networked together via public (i.e. the Internet 104) or private network, judicially located to provide maximum coverage to that area requiring most support at any time. Utilizing call distribution software residing on the servers that “follows-the-sun”, customer service representatives and experts are available around the clock and provide the most cost effective coverage, taking into account time differences, and salaries based upon shift differentials.

In the preferred business method, a subscriber purchases a service contract for a fixed calendar period. Alternatively, a subscriber may purchase support time based upon a fixed dollar amount per a specific number of hours of expert support. Not limited by the payment scheme, the subscriber receives a wireless headset 210 and wireless receiver 204 at the time of subscribing to the service. It is envisioned that customers may purchase the service off the shelf at a home improvement retail store. The package would include the headset and a login code. Alternatively, the package would have a code and a headset would be mailed to the subscriber once the subscriber sets up their account online. A further option would allow a new customer to order the service online and receive their headset 210 in the mail. Regardless of the method of ordering service and obtaining a headset 210, the subscriber must have a headset 210 before online audio and video support can be provided. Prior to termination of the subscription period, the subscriber will be prompted by the system 100 to purchase additional support.

FIG. 6 illustrates a high level flowchart of a telepresence session. The start of a session 602 begins at the subscriber's location. Once the subscriber 212 has verified operation of his headset 210, the first step 700 in obtaining telepresence support is to connect the browser on their personal computer 202 to the web site of the home improvement support center. The service center's Web application resident on their server interacts with the subscriber's browser and presents a series of menu's to the subscriber that includes a login dialog or alternatively to order service online. Once the subscriber completes the steps for an online session, the server connects the subscriber to a customer service representative 116 who verifies the subscriber's personal information, and directs the subscriber to the appropriate expert 800. The expert may at this time initiate a support session or at any time reschedule the support session to a more convenient time 900. Prior to completion of the session 604, both the subscriber and the expert generate reports 1000 documenting the session to include the quality of the service, lessons learned, and other metrics that will be used by customer service to improve the methodology and/or quality of the service provided.

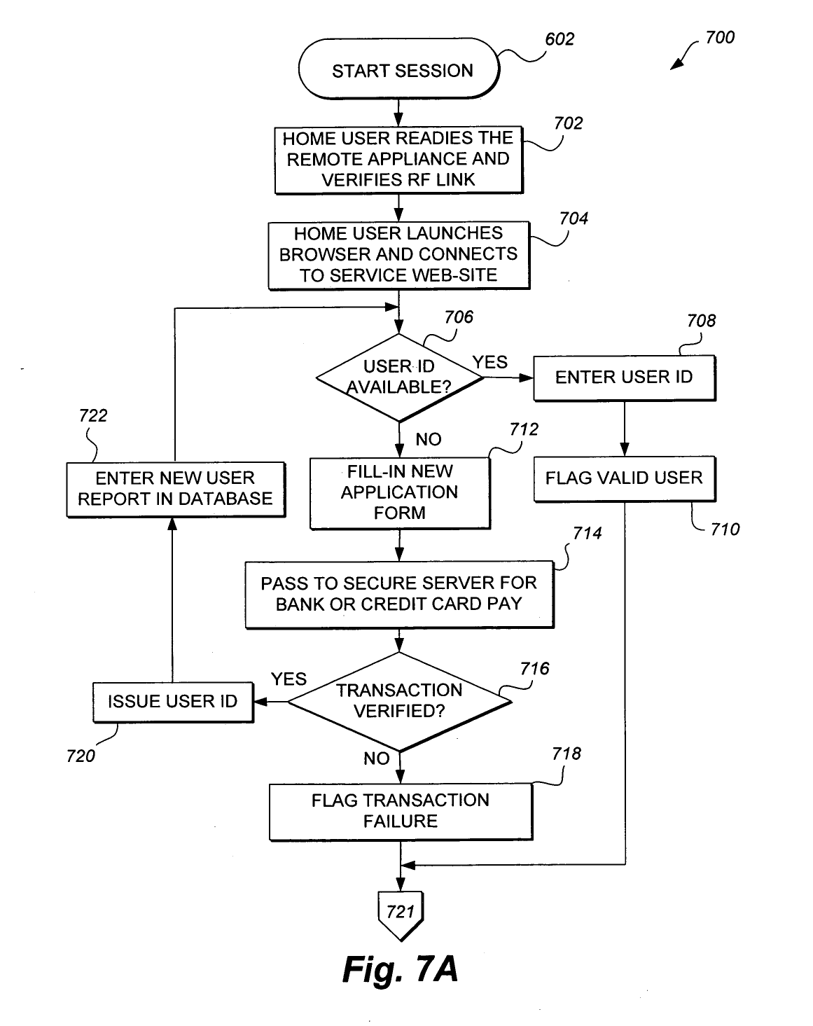

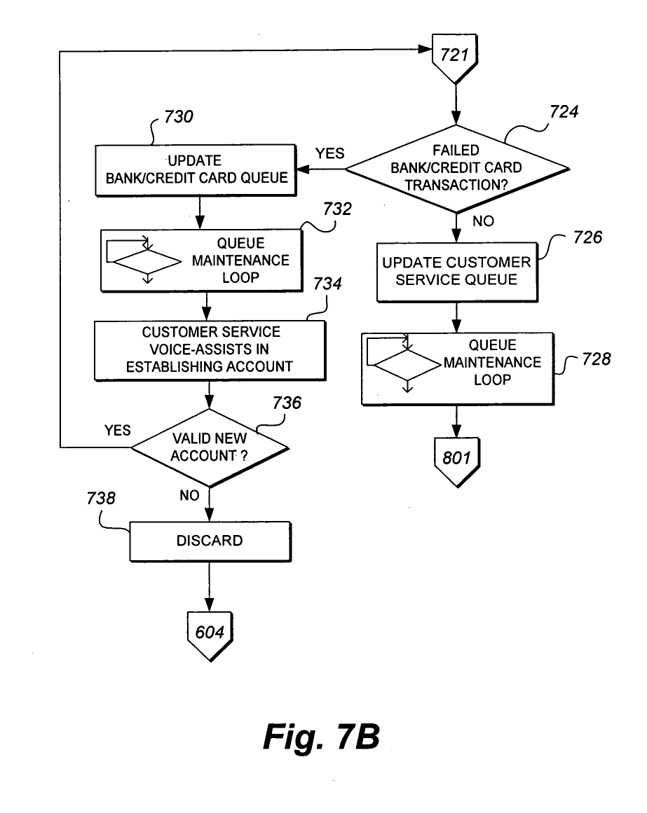

The high-level software description described in FIG. 6 is elaborated upon in greater but non-limiting detail in FIGS. 7A, 7B, and 8-10. FIGS. 7A and 7B illustrate the details of the initial connect process 700 up to the step where the call is transferred to the first customer service representative 801. The first step 702 requires the subscriber to ready the headset 210 and verify proper operation of the wireless connection to the wireless receiver 204. Once the equipment is checked, the subscriber launches a browser on his personal computer and connects to the service website 704. At this point 706, the user either logs in using their subscriber user-id 708, or fills out a new user application form or renewal form 712. The custom designed software allows a new customer to order their new wireless headset 210 and receiver 204 either online or is directed to a customer service representative at a toll free number to facilitate their request. In order to process payments online, the online call is passed 714 to a secure server 128 behind firewall 130, which communicates with a bank 132 or credit card system. When the transaction is completed 716, the subscriber is issued a new userid 720. At step 722 the new subscriber data is then entered into a database maintained on server 108 and the subscriber is again offered at step 706 the opportunity to login to the system. Should the payment request fail at step 716, a failure flag is set at step 718; otherwise the call is flagged in step 710 as being generated by a valid user. Once the payment flag is set, the valid user flag is set and program flow is directed through connector 721 to the evaluation of the payment flag at step 724 on FIG. 7B.

If the payment flag indicates a valid payment or a valid user at step 724, the user is logged in and the server 108 presents the subscriber with additional Web pages from which the subscriber has several options including but not limited to: automatic downloading of documentation, updating account profile information, viewing account historical information, entering data for a new support session, and requesting the connection to a previously scheduled support session. The business method may optionally provide hyperlinks to the web sites of home improvement retailers, allowing subscribers to browse these sites for necessary tools or supplies and the option of purchase the tools and necessary equipment either directly from the supplier or via the present business method 100. Purchases from third-parties are processed by the secure sever 128 and the subscribers account information is updated accordingly. Should the subscriber request either a new or ongoing support session, the subscriber's session is added to the customer service queue at step 726. However, if the bank or credit card information evidences a problem, the call updates a bank/credit card queue at step 730. The queue is managed at step 732 by server software that manages all the queues and updates the queues as calls are processed.

At step 734 a customer service representative answers calls sent to this queue by step 732. Depending upon the status of the account evaluated at step 736, the call results either in a valid new account whereby the appropriate call status flag is set and the call reenters the process at 724, or, the call is discarded at step 738 and exits the session process 604.

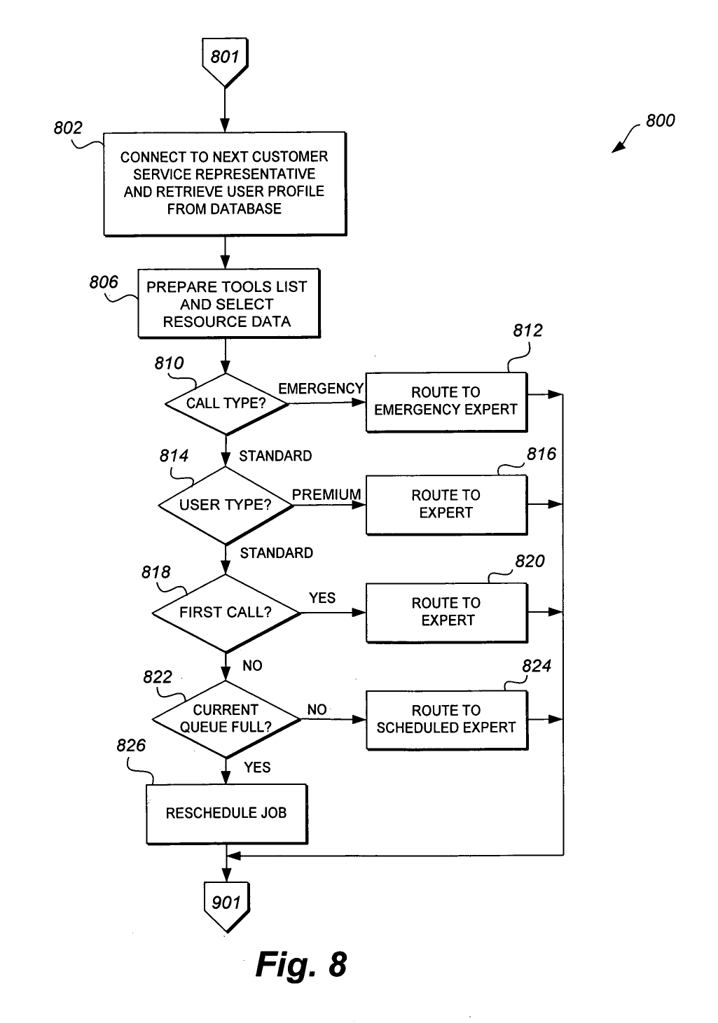

A queue maintenance loop 728 continuously monitors the status of the calls placed in queue by step 726 and is routed to the next available customer service representative as shown on FIG. 8 steps 801 and 802.

FIG. 8 represents the detailed process flow 800 at the point the system 100 connects the call to the customer service representative 802. The server program maintaining the queue interrogates the subscriber database to determine the service level agreement subscribed to by the user and places the call in the customer service representative queue based upon this determination. Should the subscriber have paid for premium service, his call is placed at the top of the customer service queue. Should the subscriber not require live assistance, but require instead documentary information such as an instruction set, most often asked questions, a context based expert system, or other written or stored video information, the subscriber is provided a menu from which they may obtain other than live assistance. This documentary information is stored in a database stored on a server.

Once the call appears on the screen of the customer service representative, the subscribers profile is presented on the screen. The customer service representative prepares a tools list and resource data based upon the job requirements 806. The support provided the subscriber is based upon a decision tree determined by the call type 810, the user type 814, the support type 818, and the availability of support 822. If the call type is an emergency such as a broken water pipe or a power outage, the call is routed to an emergency expert 812. If the call is a non-emergency, the user type is then determined by the stored profile and if the subscriber has paid for premium service, the call is placed next in line for the expert of the desired area of home maintenance 816.

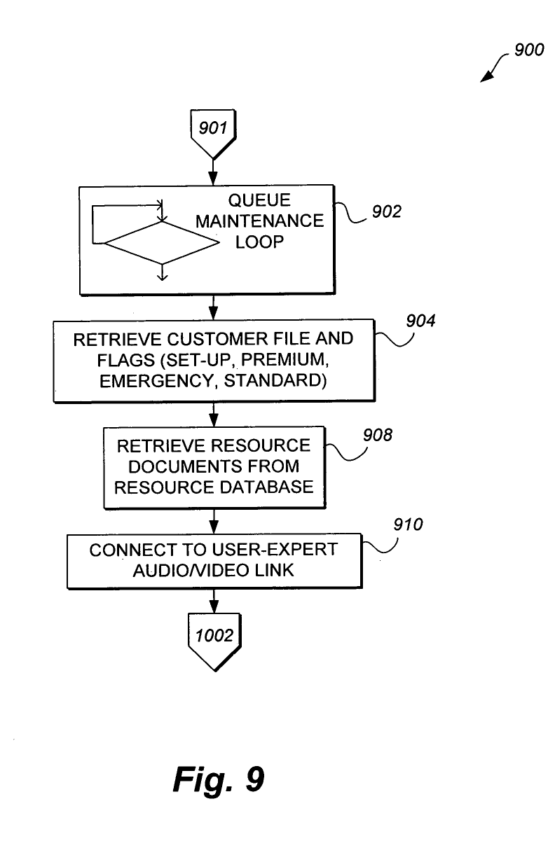

At step 818 a determination is made either by the customer service representative or by an indication in the caller profile that the current call is an initial session or a subsequent scheduled call. If the original call, the server routes the call to the appropriate expert 820. If the call has been scheduled, the queue for the appropriate expert is checked 822. If the queue is full, the subscriber is offered the opportunity to reschedule the session 826. If there is room is the queue, the call is answered in turn by the appropriate expert 824. The program flow is now directed through connector 901 to FIG. 9 step 902.

FIG. 9 illustrates process 900 in which the system connects a subscriber to an expert for a live assistance session. The system 100 puts the call into the appropriate queue 902 based upon the caller profile and the determination of the customer service representative 904. Personnel trained in at least one area of home maintenance or building skills service the support requests by the subscribers. Areas of expertise include but are not limited to: plumbing, electrical, automotive, carpentry, masonry, small engine repair and gardening. To be available to receive a session, an expert must be logged in to the system, thereby alerting the system as to what areas of support are available, and in what areas an expert is needed. Furthermore, the customer representative sign-in log can be used for time recording purposes.

The queue for live support will include a number of fields, such as the time and date of the call, amount of time in queue, the subscriber's id or account number, and specific area of concern. The system matches up the subscriber's area of concern with the next available expert having those specific qualifications. Help desk algorithms and software for allocating a common pool of resources to a large number of incoming attempts is known to those skilled in the art of help desk operations.

When a qualified expert is available, the system retrieves the subscriber's file 904, and retrieves resource documents from the resource database 908 as determined by the customer service representative or by data supplied by the subscriber. Once the expert is provided with this information, the system connects the expert by voice and video to the subscriber at step 910. It may happen that the subscriber is not ready to work online with the expert. This may happen because the subscriber is lacking all the required tools, or some other set of circumstances for which the expert decides that it is best to postpone the live session.

A further capability of the system 100 enables the expert to browse the web sites of home improvement suppliers in order to help the subscriber find required tools or merchandise that the subscriber has been unable to locate.

In addition, the system 100 maintains a record of the work schedule of the customer service personnel and can automatically schedule future support sessions based upon the area of support requested by the subscriber and the availability of technical expertise in that discipline.

Upon completion of the live session the next step is report generation initiated at step 1002, at which time both the expert and the subscriber are both provided opportunities to enter data regarding the session. The expert generates a report summarizing the on-line session 1004, including but not limited to details on the duration, difficulty, and subscriber skill. The report is filed in the system database 1006. The system 100 is heuristic in that although the knowledgebase of the system database will be limited at start-up, as experts complete sessions, the knowledge learned from prior sessions is added to the wealth of knowledge available to future experts. To this end, if the expert decides 1008 that the just completed session was non-standard, the expert may generate at step 1010 new resource documentation to be added to the resource database.

Prior to logging off and ending the session at step 604, the subscriber is asked to complete an on-line questionnaire providing feedback for quality assurance and training purposes 1012.

The system 100 provides a great number of reports and statistics including but not limited to queue size, average time in queue, average time on hold, service time, area of concern, time and date of call, and the customer service representative and expert who supported the client. Furthermore, statistics are maintained both on the performance of the customer service representatives and the experts. These statistics include, but are not limited to availability, number of calls serviced, average length of each call, and time between sessions.

It is to be understood that the present invention is not limited to the embodiment described above, but encompasses any and all embodiments within the scope of the following claims.

1. A method for providing remote real-time technical support to a home user, comprising the steps of:
establishing a wireless connection between a subscriber worn headset and a subscriber computer;
connecting the subscriber computer to an Internet service provider;
running a browser on the subscriber computer;
establishing a connection between the subscriber computer and a home improvement technical support server;
establishing a connection between the support server and a computer workstation manned by a technical expert; and
establishing a two-way audio and one way video communication channel between the subscriber and the technical expert.

2. The method of claim 1, further comprising the steps of:
validating the identity of the home user;
automatically routing the home user to a specific technical expert based upon an on-line menu presented to the home user; and
automatically scheduling a support session based upon user supplied information and the availability of technical support.

3. The method of claim 1, further comprising the step of placing technical reference data on a server available to both the technical expert and home user.

4. A home improvement telepresence system for providing remote technical assistance, comprising:
at least one subscriber station having a headset including a microphone, a video camera, and an earpiece mounted thereon, and having a subscriber computer, the headset being in wireless communication with the subscriber computer, the computer being electrically connected to a computer network; and
at least one server computer having an interface for communication over the computer network, application program means, the application program means containing instruction code for routing voice and video data from the at least one subscriber computer to the at least one customer service workstation.

5. The home improvement telepresence system according to claim 4, wherein the server computer further comprises a memory for storing data for access by the application program means, said memory further comprising a data structure stored in said memory, said data structure further comprising a data structure instantiating code segment that establishes data records including:
(a) subscriber profile information;
(b) technical expert area proficiencies;
(c) technical expert work schedules;
(d) subject matter resource data;
(e) links to computer servers of home improvement equipment providers; and
(f) historical data on past support sessions.

6. The home improvement telepresence system of claim 4, wherein said at least one server further provides a user interface wherein:
(a) subscribers may log in, update their personal profile information, request technical data schedule a future real-time support session with a technical expert, request an immediate real-time support session with a technical expert, and prepare a questionnaire regarding received service; and
(b) customer service representatives may login to the at least one computer server, enter their work schedules, view subscriber profile information, view a video feed originating from the subscriber video camera, download relevant technical documentation, download data to the subscriber workstation, and prepare support session related reports.
